(19) United States
(12) Patent Application Publication
(10) Pub. No.: US 2026/0349609 A1
(43) Pub. Date: Nov. 5, 2026

(54) Enhanced Lock Provisioning In A Data Storage Environment

(71) Applicant: NetApp, Inc., San Jose, CA (US)

(72) Inventors: Todd Jason Mills, Union City, CA (US); Stephen Dale Parsons, Los Gatos, CA (US); Aleksandr Sergeev Khasymski, San Jose, CA (US); Reyaz Ahmed, Fremont, CA (US)

(73) Assignee: NetApp, Inc., San Jose, CA (US)

(21) Appl. No.: 19/280,841

(22) Filed: Jul. 25, 2025

Related U.S. Application Data
(60) Provisional application No. 63/797,631, filed on Apr. 30, 2025.

(51) Int. Cl. G06F 3/06

(52) U.S. Cl. CPC G06F 3/0622; G06F 3/0655; G06F 3/0679

(57) ABSTRACT

The disclosure describes systems, devices, and methods for managing access and provisioning locks to storage devices with respect to security operations in data storage environments. In an example implementation, a method for provisioning access to a storage device in a data storage environment is provided. In performing the method, a shelf controller in the data storage environment receives a request to take a lock on a storage device to restrict access to the storage device with respect to security operations, identifies a status of a lock indicator associated with the storage device, and responsive to identifying that the status of the lock indicator of the storage device indicates availability with respect to the security operations, takes the lock on the storage device.

### RELATED APPLICATIONS

This application hereby claims the benefit and priority to U.S. Provisional Application No. 63/797,631, titled “ENHANCED LOCK PROVISIONING IN A DATA STORAGE ENVIRONMENT,” filed Apr. 30, 2025, which is hereby incorporated by reference in its entirety.

### TECHNICAL FIELD

Embodiments of the present disclosure relate generally to data storage technology, and in particular, to provisioning access to storage devices in a data storage environment.

### BACKGROUND

A data storage environment may employ a file system service to provide data storage and management capabilities for users and organizations. A file system service may include several controllers and an aggregate of storage devices accessible by the controllers. Each controller employs storage operating software to perform operations at respective storage devices. For example, in performing a write operation, a controller writes data to a particular location on one or more respective storage devices. Another example type of operation performed by the storage controllers at the storage devices includes security operations, such as cryptography operations, which are performed at the storage devices to ensure safety, security, and authenticity of data being written to the storage devices and stored on the storage devices.

A storage controller may request performance of a security operation upon boot or re-boot of the storage controller. However, multiple storage controllers may compete to access a finite set of communication identifiers with which to obtain access to the storage devices and perform security operations thereon. Problematically, if multiple storage controllers attempt to perform security operations at the same storage device simultaneously, some of the requests may fail as access may be limited to the storage devices by a number of storage controllers at a given time. Such access provisioning may prevent data overwriting and bottlenecking; however, it may also increase downtime of a storage controller, lead to lengthy timeouts and/or drive failure, and security issue discovery failures.

### SUMMARY

The technology described herein improves the management of access to storage devices in a data storage environment with respect to security operations. In an example implementation, a method for provisioning access to a storage device in a data storage environment is provided. In performing the method, a shelf controller in the data storage environment receives a request to take a lock on a storage device to restrict access to the storage device with respect to security operations, identifies a status of a lock indicator associated with the storage device, and responsive to identifying that the status of the lock indicator of the storage device indicates availability with respect to the security operations, takes the lock on the storage device.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter. These and other features and aspects of various examples may be understood in view of the following detailed discussion and accompanying drawings.

### BRIEF DESCRIPTION OF THE DRAWINGS

For a more complete understanding of the present invention(s), and the advantages thereof, reference is now made to the following descriptions taken in conjunction with the accompanying drawings.

FIG. 1 illustrates an example operating environment in an implementation.

FIG. 2 illustrates a method for provisioning access to a storage device of a data storage system in an implementation.

FIGS. 3A and 3B illustrate an example operating environment in an implementation.

FIG. 4 illustrates an example operational sequence in an implementation.

FIG. 5 illustrates an example software block diagram in an implementation.

FIG. 6 illustrates an example operational sequence in an implementation.

FIG. 7 illustrates a computing system suitable for implementing the various systems, operational environments, architectures, environments, methods, processes, scenarios, sequences, and frameworks discussed below with respect to the other Figures.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION

Embodiments of the present disclosure relate generally to data storage technology. More specifically, some embodiments relate to provisioning access to storage devices in a multiple node data storage environment. In some instances, the data storage environment may integrate self-encrypting drives that automatically encrypt data written to the drive and decrypt data read from the drive using built-in hardware encryption. Self-encrypting drives use unique identifiers defined by the Trusted Communication Group (TCG) standards to manage and execute security operations. In multi-node environments, each node may use a finite set of trusted of unique identifiers known as command identifiers (ComIDs) to perform essential drive security operations (e.g., drive discovery, authentication, access control key updates). These identifiers help organize and manage security tasks, ensuring that each operation is correctly directed and executed without interference.

The existing method of ComID selection assigns a unique ComID to each node when sufficient ComIDs are available (e.g., currently up to 4, depending on the drive model). When there are more nodes than ComIDs, the nodes must share overloaded ComID assignments, often leading to collisions, conflicts, and retries from nodes doing the security information exchange. The problem worsens as the number of nodes grows, increasing the likelihood of collisions beyond the usual drive's support for ComIDs. Frequent and unresolved collisions can stall security commands, lead to lengthy timeouts, discovery failures, and may even cause critical drive failures.

Various embodiments of the technology disclosed herein mitigate the problems discussed above with respect to access provisioning to storage devices in data storage environments with respect to security operations. In various embodiments, security operations refer to one or more of the following operations, including authentication key management, power-on lock management, disk sanitization and decommissioning, compliance mode activation, data encryption, disk encryption status monitoring, data decryption, secure data migration and deletion, and secure boot management and configuration, among other operations. In some such embodiments, the storage devices include self-encryption capabilities, and thus, the operations described herein may be performed to enable, facilitate, manage, and maintain the self-encrypting drives (SEDs) to ensure functionality, compliance, and integration with the data storage environment. For example, SEDs may automatically encrypt data and/or lock access to data until an authentication key is provided. A controller or node in the data storage environment can manage authentication keys with which to unlock access to data stored on the SEDs. Additionally, a controller in the data storage environment can manage firmware and/or software updates of the SEDs via security operations to ensure the SEDs operate in accordance with security and compliance standards.

Various embodiments of the present technology relate to data storage environments that include multiple controllers (interchangeably referring to the terms controllers and nodes) and a storage aggregate including multiple storage devices, where groups of the storage devices are located on drive shelves or racks that provide hardware enclosures designed to physical hold and organize multiple storage drives. The data storage environments may be structured in a shared-everything (also known as a shared-disk) architecture where each storage controller can communicate with each storage device (e.g., via a shelf controller on a respective drive shelf). However, other architectures, as well as combinations and variations thereof, may be contemplated.

In a shared-everything architecture, a single pool of storage devices is utilized for an entire cluster of storage controllers with equal and common access to the storage devices by the controllers. In some embodiments, the storage aggregate is divided into multiple RAID groups (e.g., sets of drives providing RAID functionality, where RAID stands for Redundant Array of Independent Disks), and each RAID group includes one or more data disks and one or more parity disks that provide redundancy with respect to each other. The arrangement of the storage aggregate, such as groups of storage devices (RAID groups), an order of the storage devices amongst each other, the storage blocks in each storage device, and the like, may be indicated in metadata stored among the storage devices in the storage aggregate. The arrangement and associated information may be referred to as the aggregate layout.

Groups of the storage devices of the aggregate may be located together on drive shelves or racks that physically hold all the storage devices of respective groups together. A drive shelf may additionally include one or more shelf controllers to interface between the storage controllers and the storage devices on the drive shelf. More specifically, a shelf controller communicates with the storage controllers to receive requests to perform various operations at the storage devices, and the shelf controller performs the operations at the storage devices. To perform operations at the storage devices, the storage controllers in the data storage environment run instances of a storage operating system (e.g., NetApp ONTAP®).

An example type of operation requested by the storage controllers includes security operations, such as cryptography operations, which are performed at the storage devices to ensure safety, security, and authenticity of data being written to the storage devices and stored on the storage devices. A storage controller may request performance of a security operation upon boot or re-boot of the storage controller. Problematically, if multiple storage controllers attempt to perform security operations at the same storage device (e.g., a self-encrypting storage device) simultaneously, some of the requests may fail as the access to the storage devices may be limited to a number of storage controllers at a given time. Such access provisioning may prevent data overwriting and bottlenecking; however, it may also increase downtime of a storage controller, lead to lengthy timeouts and/or drive failure, and security issue discovery failures.

To resolves such challenges, techniques are described herein for performing access provisioning to storage devices with respect to security operations by the shelf controllers of drive shelves. The shelf controllers may execute program instructions implemented in firmware and/or software to perform access provisioning as described herein. In particular, the shelf controllers interface with each of the storage controllers capable of performing I/O and security operations, among other operations. Rather than the storage controllers requesting access to the storage devices directly in the performance of security operations, the storage controllers provide requests to access the storage devices to a shelf controller(s). The shelf controller identifies whether another storage controller already has exclusive access to a storage device indicated in a request, and if not, the shelf controller provisions security-exclusive access to the storage controller. Then, the storage controller performs the security operations. When finished, the lock on the storage device is released, allowing other controllers to acquire exclusive access to the storage device. The access provisioning techniques described herein may be helpful to avoid drawbacks of uncoordinated access provisioning, which may reduce downtime and timeouts with respect to storage controller functionality and security operations, reduce the risk of data loss or data compromise, and the like.

In some example embodiments, the techniques described herein may be utilized in cloud or virtual storage environments in which encryption keys are constantly changing. In such environments, clients may request encryption and decryption of data on-demand, and with frequent key rotation, traditional ComID methods may be ineffective or inefficient. Thus, a centralized security access management system as described herein can help orchestrate access and cryptography between virtual storage nodes and virtual storage.

Various embodiments of the present technology provide for a wide range of technical effects, advantages, and/or improvements to computing systems and components. For example, various embodiments may include one or more of the following technical effects, advantages, and/or improvements: 1) non-routine and unconventional operations and algorithms for large-scale storage architectures that integrate self-encrypting drives where encryption-related tasks are managed concurrently by multiple controllers or nodes; 2) non-routine and unconventional components and operations that create a security-exclusive access (SEA) lock mechanism at the shelf (enclosure) firmware level; 3) non-routine and unconventional operations that allow nodes to request a SEA lock from the shelf firmware for exclusive rights to perform security operations; 4) non-routine and unconventional operations for management of communication IDs to mitigate collisions, conflicts, and backoff retries from nodes doing the security information exchange; 5) non-routine and unconventional operations to handle stale or “hung” locks, letting another node preempt the lock if a previously granted lock remains orphaned; 6) non-routine and unconventional operations and/or hardware modifications to create centralized arbitration by managing locks in the shelf firmware so that all nodes defer conflict resolution to a single, authoritative entity, thereby eliminating reliance on ad hoc backoff behaviors; 7) non-routine and unconventional operations and/or hardware modifications to dynamic preemption and recovery through a generation count so that nodes can detect stale or abandoned locks and force a takeover in exceptional situations, preventing indefinite blockages; 8) non-routine and unconventional operations and/or hardware modifications to creating an SEA lock approach that can accommodate a large number of nodes beyond the finite ComID resource limit that TCG drives natively support, thus significantly improving multi-node coordination; 9) non-routine and unconventional operations and/or hardware modifications to create backward compatibility allowing systems lacking advanced ComID management to continue operating in the traditional manner without modifying drive firmware or TCG compliance at the disk level; and/or 10) non-routine and unconventional operations and/or hardware modifications to reduced chances of failure by effectively eliminating (or significantly reducing) collisions that previously caused drive lockups, timeouts, and potential data unavailability using sequential, lock-based issuance of security commands.

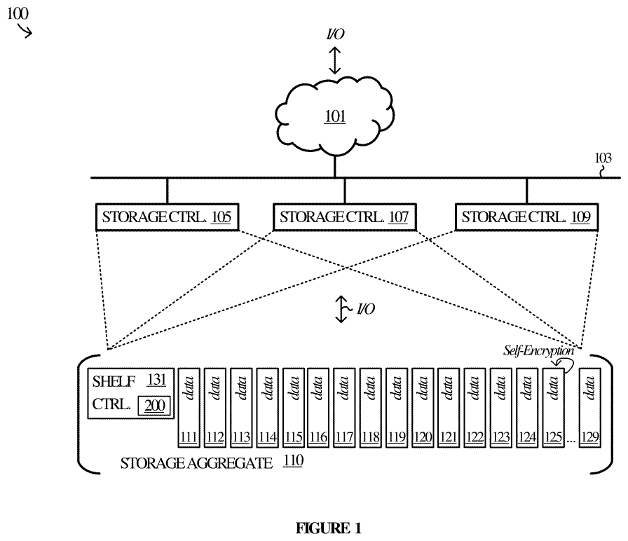

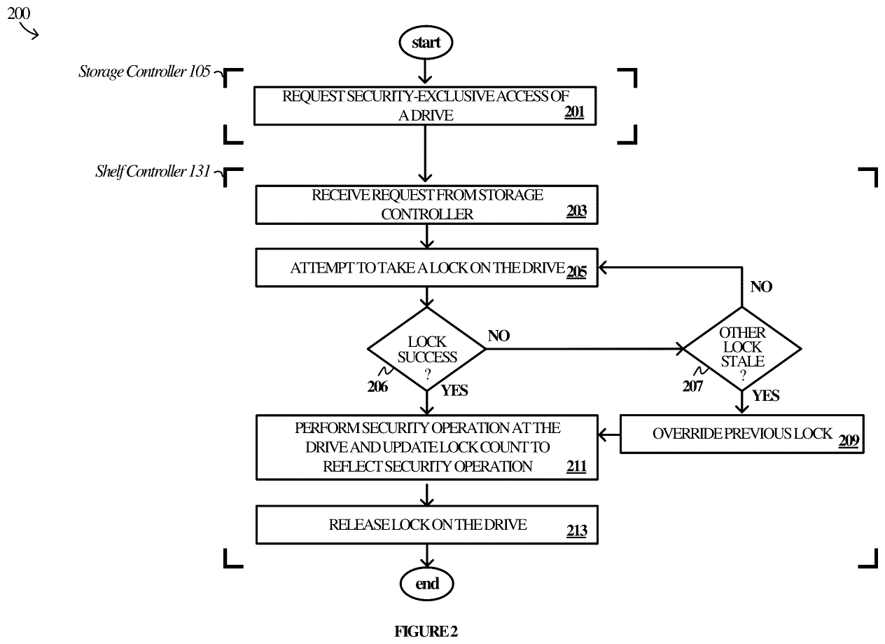

FIG. 1 illustrates an example operating environment in an implementation. FIG. 1 shows operating environment 100, which includes application 101, storage controllers 105, 107, and 109, and storage aggregate 110. Storage aggregate 110 includes a plurality of storage devices accessible by each of storage controllers 105, 107, and 109. In various embodiments, storage controllers 105, 107, and 109 may be configured to perform security-access provisioning processes, such as process 200 of FIG. 2.

In various embodiments, operating environment 100 is representative of a data storage environment that includes hardware, software, and firmware components capable of providing file system services, such as file storage and management, among other functionality. Operating environment 100 includes multiple controllers and multiple storage devices arranged in a shared-everything architecture such that each of the controllers is capable of accessing any of the storage devices. In particular, storage controllers 105, 107, and 109 can receive requests to perform input/output (I/O) operations (e.g., read operations, write operations) via network 101 and perform the I/O operations with all of the storage devices of storage aggregate 110. More specifically, storage controllers 105, 107, and 109 may be assigned permission to write at certain locations of the storage devices of storage aggregate 110, while storage controllers 105, 107, and 109 may be able to read from any locations of the storage devices.

Network 101 is representative of a communication network through which enterprise clients, servers, and devices provide read requests and write requests (i.e., I/O) to a data storage system, such as a system including storage controllers 105, 107, and 109, and storage aggregate 110. Communication between the enterprise clients and storage controllers 105, 107, and 109 may occur over network 101 and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

Storage controllers 105, 107, and 109 are representative of devices, systems, servers, or services capable of accessing and managing storage for enterprises and users in communication with storage controllers 105, 107, and 109 via network 101. Storage controllers 105, 107, and 109 also interface with each other and with storage aggregate 110 in accordance with one or more storage network and access protocols, such as Non-Volatile Memory Express (NVMe), via network 103. Other protocols such as Network File System (NFS), Server Message Block protocol (SMB), Internet Small Computer System Interface (iSCSI), Fiber Channel (FC), Fiber Channel over Ethernet (FCoE), and the like may be contemplated. By way of example, each of storage controllers 105, 107, and 109 may be a server configured to run an instance of a storage operating system (e.g., NetApp ONTAP®) to perform I/O operations based on I/O requests received through network 101, among other functions.

Storage aggregate 110 is representative of a cluster of storage devices that provide storage in operating environment 100. Examples of the storage devices include flash disks and/or capacity drives, such as hard-disk drives (HDDs) and solid state drives (SSDs), as well as combinations and variations thereof. In various embodiments, the storage devices include self-encryption hardware, software, and/or firmware, with which the storage devices automatically encrypt data written to memory thereof and decrypt data read from the memory thereof.

In various embodiments, storage aggregate 110 includes one or more groups of the storage devices, which may provide redundancy relative to one another (e.g., a RAID group, a group in an enclosure or drive shelf). For example, storage aggregate 110 may include a group of storage devices enclosed or housed in a drive shelf. Storage controllers 105, 107, and 109 may access each storage device of storage aggregate 110 based on the shared-everything architecture via shelf controller 131 of storage aggregate 110.

Shelf controller 131 is representative of a device capable of interfacing with storage controllers 105, 107, and 109 and with the storage devices of storage aggregate 110 to perform various functions. More particularly, shelf controller 131 may include software, firmware, and/or hardware coupled to a drive shelf housing the storage devices of storage aggregate 110, and coupled to one or more of the storage devices, among other physical infrastructure of the drive shelf.

In various embodiments, shelf controller 131 may be capable of performing I/O operations at the storage devices based on I/O requests provided by storage controllers 105, 107, and 109. Additionally, shelf controller 131 may be capable of performing security operations at the storage devices based on security operation requests provided by storage controllers 105, 107, and 109. The security operations may refer to cryptography operations, such as encryption and decryption, as well as other security, authenticity, and functional safety operations. With respect to the security operations, shelf controller 131 may function as a centralized lock manager for storage controllers 105, 107, and 109 requesting security operations associated with one or more of the storage devices of storage aggregate 110.

In allowing storage controllers 105, 107, and 109 to perform security operations at one or more of the storage devices, shelf controller 131 may perform security-access provisioning for storage controllers 105, 107, and 109, such as process 200 of FIG. 2, to grant permission to storage controllers 105, 107, and 109 to perform a security operation at a given storage device. Accordingly, the software, firmware, and/or hardware, as well as combinations and variations thereof, of shelf controller 131 may allow shelf controller 131 to provision access to storage controllers 105, 107, and 109. Additional details regarding the security-access provisioning are included in process 200 below with respect to FIG. 2.

In various embodiments, storage aggregate 110 may include a second shelf controller to provide redundancy in conjunction with shelf controller 131. In such embodiments, the shelf controllers are high-availability (HA) pairs for the storage devices in storage aggregate 110. As such, shelf controller 131 may provide redundancy relative to one another, and each may be capable of performing the same operations as the other. Each controller may also be capable of taking over operations of the other controller in the event of a failure.

As mentioned above, storage aggregate 110 may include groups of storage devices. Each group may be co-located on a drive shelf physically separated from other groups of storage devices. The drive shelves may be enclosures, racks, or other structures capable of physically housing a number of storage devices. In an example where storage aggregate 110 includes two drive shelves, each including a subset of the storage devices of storage aggregate 110, shelf controller 131 may be located on one of the drive shelves and perform such operations for the subset of storage devices located on the drive shelf. It follows that operating environment 100 may include additional controllers associated with each drive shelf among storage aggregate 110.

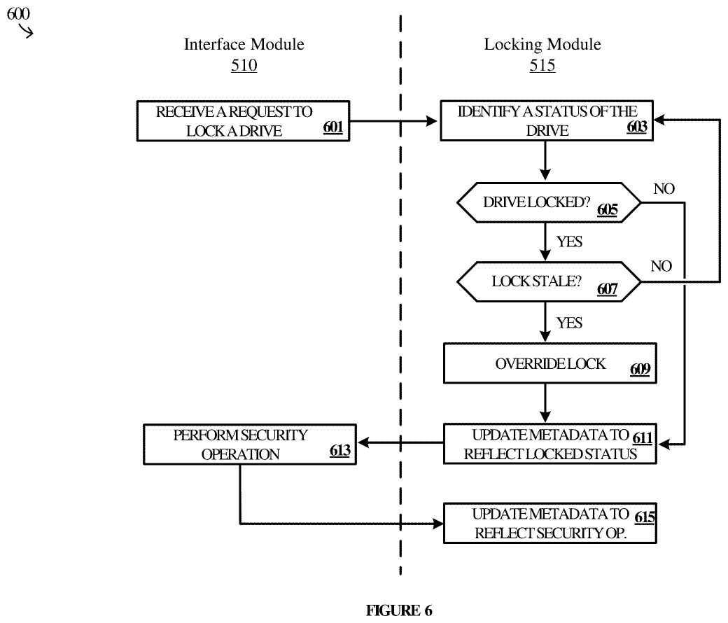

FIG. 2 illustrates a method for managing access to storage devices by controllers of a data storage environment in an implementation. Process 200 may be employed by a computing device, such as a controller of operating environment 100 (e.g., shelf controller 131), an example of which is provided by computing system 601 of FIG. 6. Accordingly, process 200 may be implemented in hardware, software, and/or firmware, and may be implemented in program instructions executable by one or more processors of the computing device. The program instructions direct the computing device to operate in accordance with the steps of process 200, which reference elements of FIG. 1. While steps of process 200 may be performed by other controllers of operating environment 100, process 200 refers to controllers 131 and 105 for the sake of simplicity.

In operation 201, storage controller 105 receives a request from storage controller 105 to perform a security operation at drive 111 of storage aggregate 110. The request may indicate a desire to lock access to drive 111 (i.e., security-exclusive access) with respect to security operations such that other controllers of operating environment 100 cannot perform security operations while access is locked by storage controller 105. The request may additionally or alternatively include an identifier associated with drive 111.

In operation 203, storage controller 105 provides the request for security-exclusive access corresponding to drive 111 to shelf controller 131. Storage controller 105 may provide the request to shelf controller 131 in accordance with a communication network and corresponding protocol established between storage controller 105 and shelf controller 131.

In operation 205, shelf controller 131 attempts to take a lock on drive 111 based on the request provided by storage controller 105. In various embodiments, this may entail shelf controller 131 identifying a status of drive 111 with respect to availability to perform security operations. Shelf controller 131 may identify the status of drive 111 by identifying an indicator stored in a data structure accessible by shelf controller 131, such as a data structure stored in memory of shelf controller 131 and/or a data structure stored in drive 111.

In operation 205, shelf controller 131 determines whether it can successfully take a lock on drive 111 for storage controller 105. For example, shelf controller 131 can successfully take a lock on drive 111 if shelf controller 131 determines that no other lock is taken on drive 111 based on the status of drive 111 with respect to the availability to perform security operations. Under such circumstances, shelf controller 131 takes the lock on drive 111, which may entail updating the status of drive 111 with respect to the availability to perform security operations. As such, the security operation availability status of drive 111 may then indicate that storage controller 105 has a security-exclusive lock on drive 111. Then, shelf controller 131 proceeds to operation 211.

However, if shelf controller 131 determines that it cannot take a lock on drive 111 in operation 205 based on the status of drive 111 indicating that a different controller (e.g., storage controller 107, storage controller 109) has a lock on drive 111, shelf controller 131 proceeds to operation 207.

In operation 207, shelf controller 131 determines whether the lock taken by the other controller is stale. To track the status of a given lock, shelf controller 131 may maintain a counter (also referred to as a “generation count”, or more simply, a “count”) associated with the lock. By way of example, each time a controller (that has taken the lock) communicates or otherwise interacts with the locked drive (e.g., performs a security operation), shelf controller 131 increments the counter. If the counter has not incremented beyond a threshold counter value within a threshold amount of time, shelf controller 131 may determine that the lock is stale. If shelf controller 131 determines that a lock is not stale, shelf controller 131 returns to operation 203 to attempt to take the lock for storage controller 105 again. However, if shelf controller 131 determines that a lock on drive 111 is stale, shelf controller 131 proceeds to operation 209.

More specifically, a stale lock may refer to an expired/abandoned lock, e.g., a lock that has not been utilized by the locking controller. An abandoned lock may be identified when the controller that has taken the lock has not performed or completed a security operation within a threshold amount of time. Shelf controller 131 may determine a count associated with the lock and compare the count with a threshold count value. The threshold count value may correspond to a number indicative of progress of the security operation over a duration based on the time at which the lock was provided to a particular storage controller. By way of example, for a security operation that should be completed within one minute, shelf controller 131 may determine a lock is abandoned by identifying that the count of the lock has not changed (i.e., the storage controller has not performed any security operations at the drive within the one minute) since the lock was taken on behalf of the storage controller. If the storage controller performs a number of operations at the drive, shelf controller 131 may reset or update the threshold amount of time so as to determine future inactivity by the storage controller. Other combinations, variations, and techniques may be used to determine abandonment or expiration of a lock.

In operation 209, shelf controller 131 overrides the previous lock taken by the other controller of operating environment 100. In various embodiments, this may entail pre-empting the security-exclusive access by the other controller and updating the status of drive 111 to reflect that storage controller 105 has the lock on drive 111 now.

Upon successfully taking a lock on drive 111, whether via pre-emption as in operation 209 or being first-in-time to take the lock as in operations 203 and 205, shelf controller 131 performs the security operation on behalf of storage controller 105 on drive 111 in operation 211. In some embodiments, however, upon taking the lock on drive 111 for storage controller 105, shelf controller 131 instructs storage controller 105 to perform the security operation directly with drive 111 instead. Regardless of implementation, shelf controller 131 may maintain a counter associated with the lock on drive 111 to ensure storage controller 105 does not control security-exclusive access to drive 111 for too long, which may reduce downtime and latency among the controllers of operating environment 100 with respect to security operations.

In operation 213, upon completion of the security operation, shelf controller 131 releases the lock on drive 111. In various embodiments, this may entail shelf controller 131 updating the status associated with the lock to indicate that drive 111 is available with respect to security operations by the controllers of operating environment 100.

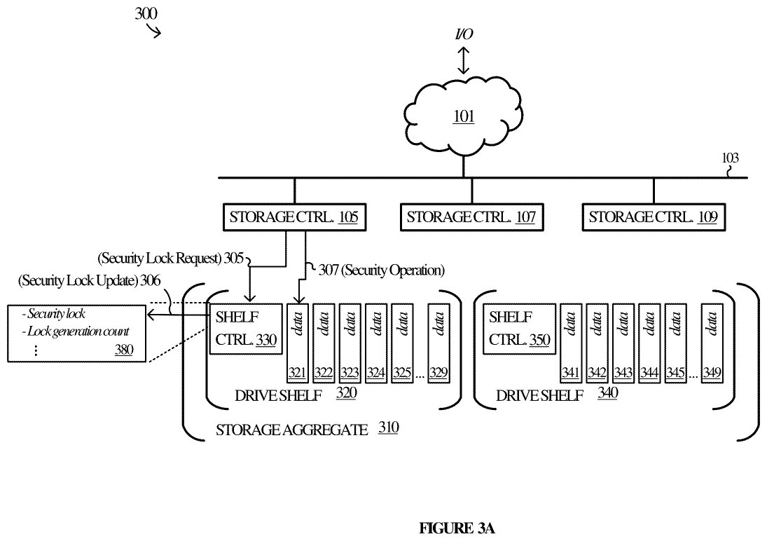

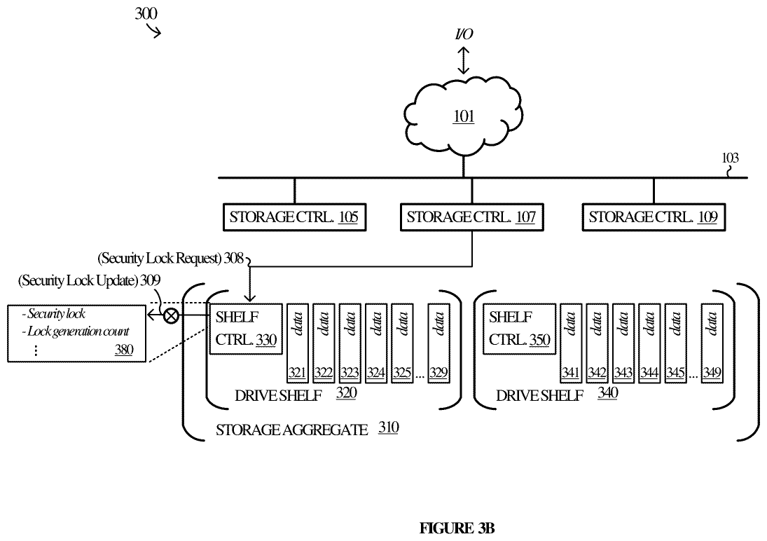

FIGS. 3A and 3B illustrate an example operating environment in an implementation. FIGS. 3A and 3B include operating environment 300, which includes and references elements of FIG. 1, such as network 101, network 103, and storage controller 105, 107, and 109. Operating environment 300 also includes storage aggregate 310, which includes drive shelf 320 and drive shelf 340, and various devices (e.g., drives) held thereon. Elements of FIGS. 3A and 3B may be configured to perform security access provisioning processes, such as process 200 of FIG. 2.

Referring generally to FIGS. 3A and 3B, operating environment 300 is representative of a data storage environment that includes hardware, software, and firmware components capable of providing file system services, such as file storage and management, among other functionality. Operating environment 300 includes multiple controllers and multiple storage devices arranged in a shared-everything architecture such that each of the controllers is capable of accessing any of the storage devices. In particular, storage controllers 105, 107, and 109 can receive requests to perform input/output (I/O) operations (e.g., read operations, write operations) via network 101 and perform the I/O operations with all of the storage devices of storage aggregate 310. More specifically, storage controllers 105, 107, and 109 may be assigned permission to write at certain locations of the storage devices of storage aggregate 310, while storage controllers 105, 107, and 109 may be able to read from any locations of the storage devices.

Storage aggregate 310 is representative of a cluster of storage devices that provide storage in operating environment 300. Examples of the storage devices include flash disks and/or capacity drives, such as hard-disk drives (HDDs) and solid state drives (SSDs), as well as combinations and variations thereof. As shown in FIG. 3, storage aggregate 310 includes drive shelf 320 and drive shelf 340, which are representative of groups of the storage devices of storage aggregate 310.

More particularly, drive shelf 320 is representative of a first group of storage devices located on or in a drive shelf (e.g., a rack, a shelf, an enclosure) that holds the storage devices, and drive shelf 340 is representative of a second group of storage devices located on or in a different drive shelf relative to drive shelf 320. Drive shelf 320 includes drives 321, 322, 323, 324, 325, and 329, and shelf controller 330. Drive shelf 340 includes drives 341, 342, 343, 344, 345, and 349, and shelf controller 350. The drives of drive shelves 320 and 340 are representative of a group of storage devices that may provide redundancy relative to one another (e.g., a RAID group, a group in an enclosure or drive shelf). Each drive shelf may additionally include physical infrastructure, such as network devices, power management devices, and the like. Drive shelves 320 and 340 may be located within proximity relative to one another, or they may be located remotely relative to one another.

Storage controllers 105, 107, and 109 may access each storage device of drive shelves 320 and 340, via shelf controller 330, and shelf controller 350, respectively, based on the shared-everything architecture. Shelf controller 330 and shelf controller 350 are representative of devices (e.g., shelf controller 131) capable of interfacing with storage controllers 105, 107, and 109 and with the storage devices of respective drive shelves to perform various functions. For example, shelf controllers 330 and 350 may be capable of performing I/O operations at the storage devices based on I/O requests provided by storage controllers 105, 107, and 109. Additionally, shelf controllers 330 and 350 may be capable of performing security operations at the storage devices based on security operation requests provided by storage controllers 105, 107, and 109. The security operations may refer to cryptography operations, such as encryption and decryption, as well as other security, authenticity, and functional safety operations.

Referring now more specifically to FIG. 3A, FIG. 3A shows operating environment 300 in which storage controller 105 attempts to take a lock on drive 321 of drive shelf 320 to perform security operation 307 therewith. In particular, storage controller 105 provides security lock request 305 to shelf controller 330 of drive shelf 320. Security lock request 305 may include an indication of the attempt to take the lock, an indication of drive 321, and an indication of the attempt to perform a security request relative to drive 321, among other information.

Shelf controller 330 receives security lock request 305 and attempts to take a lock on drive 321. In various embodiments, this may entail shelf controller 330 identifying a status of drive 321 with respect to availability to perform security operations. Shelf controller 131 may identify the status of drive 321 by identifying an indicator stored in a metadata 380 accessible by shelf controller 330, representative of as a data structure stored in memory of shelf controller 330 and/or a data structure stored in drive 321, that holds information about drive 321, among other drives in drive shelf 320.

Shelf controller 330 determines whether it can successfully take a lock on drive 321 for storage controller 105 based on metadata 380. For example, controller 321 can successfully take a lock on drive 321 if shelf controller 330 determines that no other lock is taken on drive 321 based on the status of drive 321 with respect to the availability to perform security operations. Under such circumstances, shelf controller 330 updates metadata 380 via security lock update 306 to take the lock on drive 321. In particular, this may entail updating the status of drive 321 in metadata 380 with respect to the availability to perform security operations. As such, the security operation availability status of drive 321 may then indicate that storage controller 105 has a security-exclusive lock on drive 321.

Upon successfully taking a lock on drive 321, shelf controller 330 may provide an indication of success to storage controller 105. Alternatively, or additionally, storage controller 105 may read metadata 380 to determine that security lock request 305 is successful. In response to successfully taking the lock on drive 321, storage controller 105 performs security operation 307 at drive 321.

Referring next to FIG. 3B, FIG. 3B shows operating environment 300 in which storage controller 107 attempts to take a lock on drive 321 after storage controller 105, or another controller, takes the lock on drive 321, such as in the example shown and described with respect to FIG. 3A. In this example shown in FIG. 3B, storage controller 107 provides security lock request 308 to shelf controller 330 indicative of an attempt to take a lock on drive 321.

Shelf controller 330 receives security lock request 308 and attempts to take the lock on drive 321 based on security lock request 308. This may entail determining whether drive 321 is available to be locked with respect to security operations by storage controller 107. To do so, shelf controller 330 reads metadata 380 to identify a status of drive 321 with respect to security operations and with respect to a security-exclusive access lock. Shelf controller 330 determines that drive 321 is locked by storage controller 105, and thus, security lock update 309 fails, at least temporarily.

Optionally, shelf controller 330 determines whether the lock taken by the other controller is stale. A stale lock may refer to an expired lock or a lock that has not been utilized by the locking controller. In other words, the controller that has taken the lock has not performed a security operation within a threshold amount of time. To track the status of a given lock, shelf controller 330 may maintain a counter associated with the lock in metadata 380. By way of example, each time a controller (that has taken the lock) communicates or otherwise interacts with the locked drive (e.g., performs a security operation), shelf controller 330 increments the counter in metadata 380. If the counter has not incremented beyond a threshold counter value within a threshold amount of time, shelf controller 330 may determine that the lock is stale. If shelf controller 330 determines that a lock is not stale, shelf controller 330 performs security lock update 309 again until shelf controller 330 is successful (or until shelf controller 330 has attempted security lock update 309 a threshold number of times or over the course of a threshold duration, for example). However, if shelf controller 330 determines that a lock on drive 321 is stale, shelf controller 330 overrides the previous lock taken by the other controller. In various embodiments, this may entail pre-empting the security-exclusive access by the other controller and updating the status of drive 321 in metadata 380 to reflect that storage controller 107 has the lock on drive 321 now.

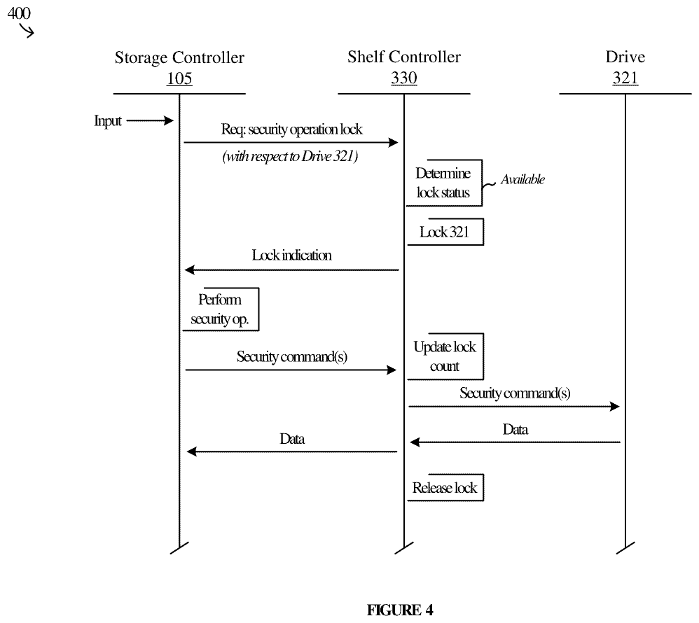

FIG. 4 illustrates operational sequence 400 demonstrative of an example sequence of events performable by elements of operating environment 300 in an implementation. In particular, operational sequence 400 includes various steps performed by storage controller 105, shelf controller 330, and storage device 321 of operating environment 300.

To begin operational sequence 400, storage controller 105 first receives an input. By way of example, storage controller 105 may receive a request to encrypt data from a client. By way of another example, storage controller 105 may receive an input to perform a security operation at a drive upon boot of storage controller 105 and/or the drive. After receiving the input, storage controller 105 determines to perform a security operation at a drive of storage aggregate 310 and provides a request to perform the security operation to shelf controller 330, which is associated with the particular drive subject to the security operation. The request (e.g., security lock request 305) may include an indication of the attempt to take the lock, an indication of the storage device subject to the security operation (e.g., drive 321), and an indication of the attempt to perform a security request relative to drive 321, among other information.

Shelf controller 330 receives security lock request 305 and attempts to take a lock on drive 321. In various embodiments, this may entail shelf controller 330 identifying a status of drive 321 with respect to availability to perform security operations. Shelf controller 131 may identify the status of drive 321 by identifying an indicator stored in a metadata 380 accessible by shelf controller 330, representative of as a data structure stored in memory of shelf controller 330 and/or a data structure stored in drive 321, that holds information about drive 321, among other drives in drive shelf 320.

Shelf controller 330 determines whether it can successfully take a lock on drive 321 for storage controller 105 based on metadata 380. For example, controller 321 can successfully take a lock on drive 321 if shelf controller 330 determines that no other lock is taken on drive 321 based on the status of drive 321 with respect to the availability to perform security operations. Under such circumstances, shelf controller 330 updates metadata 380 via security lock update 306 to take the lock on drive 321. In particular, this may entail updating the status of drive 321 in metadata 380 with respect to the availability to perform security operations. As such, the security operation availability status of drive 321 may then indicate that storage controller 105 has a security-exclusive lock on drive 321.

Upon successfully taking a lock on drive 321, shelf controller 330 may provide an indication of success to storage controller 105. Alternatively, or additionally, storage controller 105 may read metadata 380 to determine that security lock request 305 is successful.

In response to successfully taking the lock on drive 321, storage controller 105 performs security operation 307 at drive 321. In some embodiments, this may entail storage controller 105 issuing one or more security commands directly to drive 321. In some embodiments, this may entail storage controller 105 providing the security commands to shelf controller 330, then shelf controller 330 performing the security commands on behalf of storage controller 105. Shelf controller 330 updates a lock count associated with the security-exclusive lock for each security command provided/performed by storage controller 105. Drive 321 returns data and/or an indication of success (e.g., an acknowledgement) following each security command. Drive 321 may return the data/acknowledgement directly to storage controller 105, or it may return the data/acknowledgement to shelf controller 330.

Upon completion of the security operation, shelf controller 330 releases the lock on drive 321 held by storage controller 105 by updating metadata 380. Other controllers may then request security-exclusive access to drive 321.

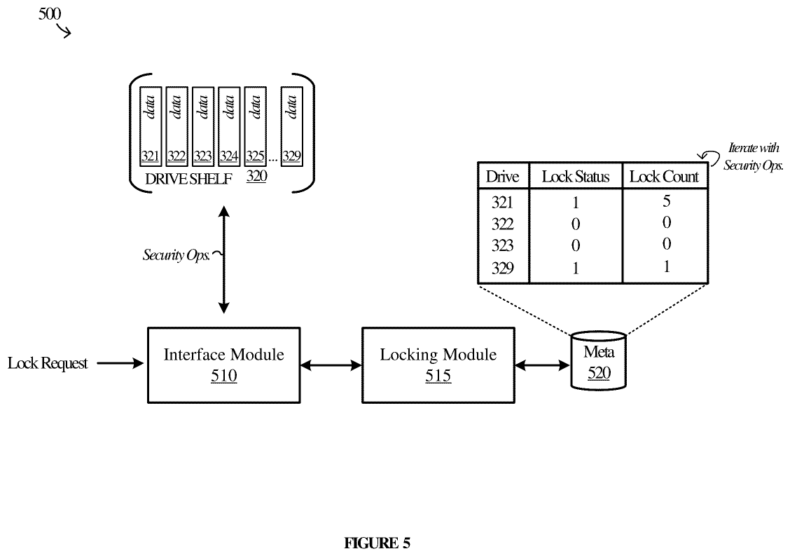

FIG. 5 illustrates a block diagram of software and firmware elements of a controller in a data storage environment in an embodiment. FIG. 5 illustrates architecture 500, which includes interface module 510 and locking module 515, and which references elements of operating environment 300. In various embodiments, architecture 500 is representative of software and/or firmware modules implemented by one or more controllers of a data storage system, such as one or more of shelf controller 131 of operating environment 100, and/or one or more of shelf controllers 330 and 350 of operating environment 300, an example of which is provided by computing system 601 of FIG. 6. It follows that the operations performed by interface module 510 and locking module 515 may be implemented in software, firmware, and/or hardware, as well as combinations and variations thereof.

In various embodiments, interface module 510 is representative of a software or firmware module of a controller of a storage aggregate, such as shelf controller 330 of storage aggregate 310. Interface module 510 may be capable of interfacing with storage controllers in a data storage system, such as controllers 105, 107, and/or 109, and with storage devices in the storage aggregate, such as drives 321, 322, 323, 324, 325, and 329 of drive shelf 320.

Locking module 515 is representative of another software or firmware module of the controller. Locking module 515 may be capable of determining a status of drives among a drive shelf, updating the status of the drives to reflect a lock or a release of a lock on the drives, and maintaining a counter with respect to a lock taken on a drive. In particular, locking module 515 may read from and write to metadata 520, representative of metadata indicative of such information about the drives and controllers of the data storage system, to do so. With respect to maintaining the counter, locking module 515 may increment or decrement a counter value based on operations performed by a storage controller at a particular drive or based on communications between the storage controller and the particular drive. Locking module 515 may further compare the counter with one or more threshold count values indicative of ongoing performance or completion of security operations by the storage controller. By way of example, a count value indicative of ongoing performance may include a value corresponding to (e.g., matching) a number of operations performed by a storage controller or a number of communications between the controller and the particular drive. A count value indicative of completion of security operations may include a value corresponding to a predetermined number of operations it takes to complete a security operation.

In operation, a controller provides a lock request to interface module 510 to attempt to take a lock on a drive of drive shelf 320 with respect to security operations. The lock request may include an indication of the attempt to take the lock, an indication of a drive to be locked, and an indication of the attempt to perform a security request relative to the target drive, among other information.

Interface module 510 receives the lock request and provides the request to locking module 515 to attempt to take a lock on the drive of drive shelf 320. Then, locking module 515 attempts to take the lock on the drive indicated in the request. In various embodiments, this may entail locking module 515 identifying a status of the drive with respect to availability to perform security operations. Locking module 515 may identify the status of the drive by identifying an indicator corresponding to lock status in metadata 520 accessible by locking module 515. Metadata 520 may be representative of as a data structure stored in memory of a controller of drive shelf 320 and/or a data structure stored in one or more of the drives of drive shelf 320.

Locking module 515 determines whether it can successfully take a lock on the specified drive based on the lock status indicated in metadata 520. For example, locking module 515 can successfully take a lock on drive 322 as metadata 520 indicates a lock status corresponding to available (“0”), but locking module 515 may be unsuccessful in taking a lock on drives 321 and 329 based on metadata 520 indicating a lock status corresponding to locked (“1”).

For a lock request corresponding to drive 322, locking module 515 determines that no other lock is taken on drive 322 based on the status of drive 322 with respect to the availability to perform security operations. Under such circumstances, locking module 515 can update metadata 520 to take the lock on drive 322, such as by updating the lock status of drive 322. Upon successfully taking a lock on drive 322, the requesting controller performs a security operation at drive 322.

For a lock request corresponding to drive 329, locking module 515 determines that drive 329 is locked based on the status of drive 329. Under such circumstances, locking module 515 next determines whether the lock status associated with drive 329 is stale or not. A stale lock may refer to an expired lock or a lock that has not been utilized by the locking controller. In other words, the controller that has taken the lock has not performed a security operation within a threshold amount of time. To track the status of a given lock, locking module 515 may maintain a counter associated with the lock in metadata 520 as indicated by lock count. By way of example, each time a controller (that has taken the lock) communicates or otherwise interacts with the locked drive (e.g., performs a security operation), locking module 515 increments lock count in metadata 520. If the counter has not incremented beyond a threshold counter value within a threshold amount of time, locking module 515 may determine that the lock is stale.

Following this example pertaining to drive 329, locking module 515 identifies that lock count associated with drive 329 indicates a value of 1. Assuming the lock on drive 329 was taken after a threshold duration, locking module 515 may determine that the locking controller has not performed a threshold number of operations, and thus, lock count has not met or exceeded a threshold lock count. As such, locking module 515 determines that the lock associated with drive 329 is stale. As a result, locking module 515 pre-empts the lock on drive 329 and updates metadata 520 to indicate that drive 329 is locked by the requesting controller.

For a lock request corresponding to drive 321, locking module 515 determines that lock 321 is locked based on the status of drive 321, and further determines that the lock count meets or exceeds a threshold lock count. Thus, locking module 515 determines that the lock associated with drive 321 is not stale. As a result, locking module 515 provides an indication to interface module 510 that the lock request has failed, and interface module 510 returns an indication to the requesting controller that the lock request has failed.

FIG. 6 illustrates operational sequence 600 demonstrative of an example sequence of events performable by elements of operating environment 600 in an implementation. In particular, operational sequence 600 includes various steps performed by interface module 510 and locking module 515 of operating environment 500.

To begin operational sequence 600, interface module 510 receives a request to lock a drive of drive shelf 320 in operation 601. The lock request may include an indication of the attempt to take the lock, an indication of a drive to be locked, and an indication of the attempt to perform a security request relative to the target drive, among other information.

Interface module 510 receives the lock request and provides the request to locking module 515 to attempt to take a lock on the drive of drive shelf 320. In operation 603, locking module 515 attempts to take the lock on the drive indicated in the request. In various embodiments, this may entail locking module 515 identifying a status of the drive with respect to availability to perform security operations. Locking module 515 may identify the status of the drive by identifying an indicator corresponding to lock status in metadata 520 accessible by locking module 515. Metadata 520 may be representative of as a data structure stored in memory of a controller of drive shelf 320 and/or a data structure stored in one or more of the drives of drive shelf 320.

In operation 605, locking module 515 determines whether it can successfully take a lock on the specified drive based on the lock status indicated in metadata 520. For example, locking module 515 can successfully take a lock on drive 322 as metadata 520 indicates a lock status corresponding to available (“0”), but locking module 515 may be unsuccessful in taking a lock on drives 321 and 329 based on metadata 520 indicating a lock status corresponding to locked (“1”).

For an unlocked drive, or a drive associated with a lock status indicative of available, locking module 515 proceeds to operation 611 in which locking module 515 updates metadata 520 to reflect the locked status of the drive. Then, in operation 613, interface module 510 performs the security operation on behalf of the request controller. Alternatively, in some embodiments, the controller performs the security operation in response to receiving an indication that the lock request is successful.

For a locked drive, or a drive associated with a lock status indicative of unavailable, locking module 515 proceeds to operation 607. In operation 607, locking module 515 determines whether the lock status associated with drive 329 is stale or not. A stale lock may refer to an expired lock or a lock that has not been utilized by the locking controller. In other words, the controller that has taken the lock has not performed a security operation within a threshold amount of time. To track the status of a given lock, locking module 515 may maintain a counter associated with the lock in metadata 520 as indicated by lock count. By way of example, each time a controller (that has taken the lock) communicates or otherwise interacts with the locked drive (e.g., performs a security operation), locking module 515 increments lock count in metadata 520. If the counter has not incremented beyond a threshold counter value within a threshold amount of time, locking module 515 may determine that the lock is stale.

In operation 607, for a lock that is not stale, locking module 515 returns to operation 503 to attempt to take the lock on the drive again. Locking module 515 may iteratively perform these steps until the lock is successful or until a threshold number of attempts have been reached. For a lock that is stale, locking module 515 proceeds to operation 609 in which locking module 515 overrides the lock status associated with the drive. This may entail releasing the lock on the drive from control of the previous lock-owning controller.

In operation 611, locking module 515 updates metadata 520 to reflect that the drive is locked under the control of the requesting controller. Then, locking module 515 may provide an indication of the lock success to interface module 510. Then, in operation 513, interface module 510 performs the security operation on behalf of the request controller. Alternatively, in some embodiments, the controller performs the security operation in response to receiving an indication that the lock request is successful.

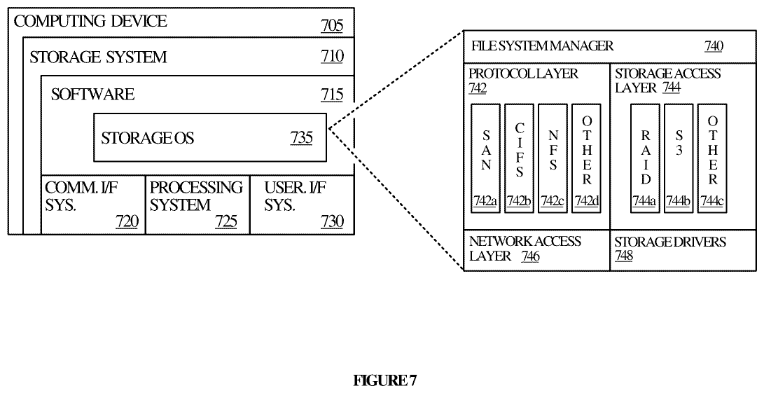

Referring now to FIG. 7, FIG. 7 illustrates computing device 705, which is representative of any system or collection of systems in which the various applications, processes, services, and scenarios disclosed herein may be implemented. Examples of computing apparatus illustrated by computing device 705 include, but are not limited to server computers, web servers, cloud computing platforms, and data center equipment, as well as any other type of physical or virtual server machine, container, and any variation or combination thereof. In some examples, computing device 705 may also be representative of desktop and laptop computers, tablet computers, and the like.

In some cases, computing device 705 is representative of a storage controller in a data storage system. In such cases, storage operating system 735 is representative of a generic example of an operating system of a storage controller. In one example, storage operating system 735 may include several modules, or “layers” executed by one or both of a network module and a storage module. These layers include a file system manager 740 that keeps track of a hierarchical structure of the stored data and manages read/write operation, i.e., executes read/write operation on storage in response to I/O requests, as described above in detail. In some cases, file system manager 740 interfaces with a failover module during a failover operation to enable access to storage managed by a failed storage system node via a partner storage system node.

Storage operating system 735 may also include a protocol layer 742 and an associated network access layer 746, to allow storage nodes to communicate over a network with other systems, such as network 101 of FIG. 1. Protocol layer 742 may implement one or more of various higher-level network protocols, such as SAN (e.g., iSCSI) (742a), CIFS (742b), NFS (742c), Hypertext Transfer Protocol (HTTP) (not shown), TCP/IP (not shown) and others (742d).

Network access layer 746 may include one or more drivers, which implement one or more lower-level protocols to communicate over the network, such as Ethernet. Interactions between host systems and mass storage devices are illustrated schematically as a path, which illustrates the flow of data through storage operating system 735.

The storage operating system 735 may also include a storage access layer 744 and an associated storage driver layer 748 to allow a storage controller to communicate with a storage device. The storage access layer 744 may implement a higher-level storage protocol, such as RAID (744a), a S3 layer 744b to access a capacity tier for object-based storage (not shown), and other layers 744c. In particular, process 200 is representative of at least a portion of software upgrade process by processing system 725. The storage driver layer 748 may implement a lower-level storage device access protocol, such as Fiber Channel or SCSI. The storage driver layer 748 may maintain various data structures (not shown) for storing information regarding storage volume, aggregate and various storage devices.

As used herein, the term “storage operating system” generally refers to the computer-executable code operable on a computer to perform a storage function that manages data access and may, in the case of a storage system node, implement data access semantics of a general-purpose operating system. The storage operating system can also be implemented as a microkernel, an application program operating over a general-purpose operating system, or as a general-purpose operating system with configurable functionality, which is configured for storage applications as described herein.

In addition, it will be understood to those skilled in the art that the disclosure described herein may apply to any type of special-purpose (e.g., file server, filer or storage serving appliance) or general-purpose computer, including a standalone computer or portion thereof, embodied as or including a storage system. Moreover, the teachings of this disclosure can be adapted to a variety of storage system architectures including, but not limited to, a network-attached storage environment, a storage area network and a storage device directly attached to a client or host computer. The term “storage system” should therefore be taken broadly to include such arrangements in addition to any subsystems configured to perform a storage function and associated with other equipment or systems. It should be noted that while this description is written in terms of a write any-where file system, the teachings of the present disclosure may be utilized with any suitable file system, including a write in place file system.

Computing device 705 may be implemented as a single apparatus, system, or device or may be implemented in a distributed manner as multiple apparatuses, systems, or devices. Computing device 705 includes, but is not limited to, processing system 725, storage system 710, software 715, communication interface system 720, and user interface system 730. Processing system 725 is operatively coupled with storage system 710, communication interface system 720, and user interface system 730.

Processing system 725 loads and executes software 715 from storage system 710. Software 715 includes and implements storage operating system 735, which is representative of the processes discussed with respect to the preceding Figures. When executed by processing system 725, software 715 directs processing system 725 to operate as described herein for at least the various processes, operational scenarios, and sequences discussed in the foregoing implementations. Computing device 705 may optionally include additional devices, features, or functionality not discussed for purposes of brevity.

Referring still to FIG. 7, processing system 725 may include a micro-processor and other circuitry that retrieves and executes software 715 from storage system 710. Processing system 725 may be implemented within a single processing device but may also be distributed across multiple processing devices or sub-systems that cooperate in executing program instructions. Examples of processing system 725 include general purpose central processing units, microcontroller units, graphical processing units, application specific processors, integrated circuits, application specific integrated circuits, and logic devices, as well as any other type of processing device, combinations, or variations thereof.

Storage system 710 may comprise any computer readable storage media readable by processing system 725 and capable of storing software 715. Storage system 710 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 710 may be implemented as a single storage device but may also be implemented across multiple storage devices or sub-systems co-located or distributed relative to each other. Storage system 710 may comprise additional elements, such as a controller, capable of communicating with processing system 725 or possibly other systems.

Software 715 (including storage operating system 735) may be implemented in program instructions and among other functions may, when executed by processing system 725, direct processing system 725 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 715 may include additional processes, programs, or components, such as operating system software, virtualization software, or other application software. Software 715 may also comprise firmware or some other form of machine-readable processing instructions executable by processing system 725.

In general, software 715, when loaded into processing system 725 and executed, transforms a suitable apparatus, system, or device (of which computing device 705 is representative) overall from a general-purpose computing system into a special-purpose computing system customized to support storage processes as described herein. Indeed, encoding software 715 on storage system 710 may transform the physical structure of storage system 710. The specific transformation of the physical structure may depend on various factors in different implementations of this description. Examples of such factors may include, but are not limited to, the technology used to implement the storage media of storage system 710 and whether the computer-storage media are characterized as primary or secondary storage, as well as other factors.

For example, if the computer readable storage media are implemented as semiconductor-based memory, software 715 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 720 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 705 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method for operating a shelf controller in a data storage environment, the method comprising, by the shelf controller:
receiving a request from a storage controller in the data storage environment to take a lock on a storage device of the data storage environment to restrict access to the storage device with respect to security operations;
identifying a status of a lock indicator associated with the storage device; and
responsive to identifying that the status of the lock indicator of the storage device indicates availability with respect to the security operations, taking the lock on the storage device.

2. The method of claim 1, wherein the data storage environment comprises a storage aggregate including multiple storage devices and multiple storage controllers, wherein at least one of the multiple storage devices includes a self-encrypting storage device, wherein subsets of the multiple storage devices are associated with drive shelves, each drive shelf including one or more shelf controllers, and wherein each of the multiple storage controllers is capable of communicating with each of the multiple storage devices via the associated one or more shelf controllers.

3. The method of claim 1, wherein taking the lock on the storage device comprises editing the lock indicator associated with the storage device to reflect that the storage device is locked for access with respect to the security operations by the shelf controller.

4. The method of claim 1, further comprising:
responsive to identifying that the status of the lock indicator indicates that the storage device is unavailable with respect to the security operations, determining whether the status of the lock indicator is valid, wherein:
determining whether the status of the lock indicator is valid comprises identifying a count associated with the lock indicator and performing a comparison between the count and a threshold count value;
responsive to determining the status of the lock indicator is valid based on a result of the comparison, rejecting the request; and
responsive to determining the status of the lock indicator is invalid based on a result of the comparison, editing the lock indicator associated with the storage device to reflect that the storage device is locked for access with respect to the security operations by the shelf controller.

5. The method of claim 4, wherein the count associated with the lock indicator comprises a value incremented in association with performance of the security operations by the storage controller.

6. The method of claim 5, wherein the threshold count value comprises a value indicative of ongoing performance or completion of the security operations by the storage controller.

7. The method of claim 1, further comprising, by the shelf controller, responsive to performance of a security operation at the storage device, releasing the lock on the storage device by editing the lock indicator associated with the storage device to reflect that the storage device is available for access with respect to the security operations.

8. The method of claim 1, further comprising, by the shelf controller:
upon taking the lock on the storage device, receiving a request from the storage controller to perform an input/output operation at the storage device;
determining that the lock corresponds to the storage controller;
allowing performance of the input/output operation at the storage device; and
incrementing a count associated with the lock indicator upon performance of the input/output operation.

9. A computing apparatus comprising:
one or more computer-readable storage media; and
program instructions stored on the one or more computer-readable storage media executable by a processing device that, based on being read and executed by the processing device, direct the processing device to:
receive a request from a storage controller in a data storage environment to take a lock on a storage device of the data storage environment to restrict access to the storage device with respect to security operations;
identify a status of a lock indicator associated with the storage device; and
responsive to identifying that the status of the lock indicator of the storage device indicates availability with respect to the security operations, take the lock on the storage device.

10. The computing apparatus of claim 9, wherein the data storage environment comprises a storage aggregate including multiple storage devices and multiple storage controllers, wherein at least one of the multiple storage devices includes a self-encrypting storage device, wherein subsets of the multiple storage devices are associated with drive shelves, each drive shelf including one or more shelf controllers, and wherein each of the multiple storage controllers is capable of communicating with each of the multiple storage devices via the associated one or more shelf controllers.

11. The computing apparatus of claim 9, wherein to take the lock on the storage device, the program instructions direct the processing device to edit the lock indicator associated with the storage device to reflect that the storage device is locked for access with respect to the security operations.

12. The computing apparatus of claim 9, wherein the program instructions further direct the processing device to:
responsive to identifying that the status of the lock indicator indicates that the storage device is unavailable with respect to the security operations, determine whether the status of the lock indicator is valid by identifying a count associated with the lock indicator and performing a comparison between the count and a threshold count value; and
responsive to determining the status of the lock indicator is valid based on a result of the comparison, reject the request; and
responsive to determining the status of the lock indicator is invalid based on a result of the comparison, edit the lock indicator associated with the storage device to reflect that the storage device is locked for access with respect to the security operations by the shelf controller.

13. The computing apparatus of claim 12, wherein:
the count associated with the lock indicator comprises a value incremented in association with performance of the security operations by the storage controller; and
the threshold count value comprises a value indicative of ongoing performance or completion of the security operations by the storage controller.

14. The computing apparatus of claim 9, wherein the program instructions further direct the processing device to, responsive to perform a security operation at the storage device, release the lock on the storage device based on editing the lock indicator associated with the storage device to reflect that the storage device is available for access with respect to the security operations.

15. The computing apparatus of claim 9, wherein the program instructions further direct the processing device to, upon taking the lock on the storage device:
receive a request to perform an input/output operation at the storage device; and
allow performance of the input/output operation at the storage device.

16. A system comprising:
one or more storage controllers; and
one or more disk shelves designed to physically hold multiple storage devices,
wherein the multiple storage devices include at least one self-encrypting drive; and
wherein each disk shelf includes one or more shelf controllers to provide a centralized lock manager for the one or more storage controllers requesting security operations associated with one or more storage devices of the multiple storage devices.

17. The system of claim 16, wherein the one or more shelf controllers on the one or more disk shelves receives a request from a storage controller of the one or more storage controllers to take a lock on a first storage device of the multiple storage devices to restrict access to the first storage device with respect to security operations and creates a lock on the first storage device upon determining the device is not locked.

18. The system of claim 17, wherein to take the lock on the first storage device, the one or more shelf controllers is configurable to edit an indicator in metadata associated with the lock to reflect that the first storage device is locked for access with respect to the security operations by the storage controller and is unavailable for editing by other storage controllers.

19. The system of claim 17, wherein the one or more storage controllers access a generation count to detect an abandoned lock and initiate with the one or more shelf controllers a release of the abandoned lock.

20. The system of claim 17, wherein the one or more shelf controllers include firmware that manages a lock table indexed by a drive identifier and a communication identifier.

21. The system of claim 17, wherein the storage controller performs a security operation with the first storage device upon creating the lock on the first storage device.

22. One or more non-transitory computer-readable storage media having stored thereon program instructions executable by one or more processors, that, when executed by the one or more processors, direct the one or more processors to:
receive a request from a storage controller in a data storage environment to take a lock on a storage device of the data storage environment;
identify a status of a lock indicator associated with the storage device; and
creating a lock on the storage device when the status of the lock indicator of the storage device indicates availability with respect to the security operations.

23. The one or more non-transitory computer-readable storage media of claim 22, wherein the program instructions further direct the one or more processors to:
responsive to identifying that the status of the lock indicator indicates that the storage device is unavailable with respect to the security operations, determine whether the status of the lock indicator is valid by identifying a count associated with the lock indicator and performing a comparison between the count and a threshold count value;
responsive to determining the status of the lock indicator is valid based on a result of the comparison, reject the request; and
responsive to determining the status of the lock indicator is invalid based on a result of the comparison, edit the lock indicator associated with the storage device to reflect that the storage device is locked for access with respect to the security operations by the shelf controller.

24. The one or more non-transitory computer-readable storage media of claim 22, wherein the program instructions further direct the one or more processors to, responsive to performance of a security operation at the storage device, release the lock on the storage device based on editing the lock indicator associated with the storage device to reflect that the storage device is available for access with respect to the security operations.

25. The one or more non-transitory computer-readable storage media of claim 24, wherein the program instructions further direct the one or more processors to:
upon taking the lock on the storage device, receive a request to perform an input/output operation at the storage device; and
allow performance of the input/output operation at the storage device.
